(19) United States
(12) Patent Application Publication
(10) Pub. No.: US 2018/0374017 A1
(43) Pub. Date: Dec. 27, 2018

(54) SYSTEM AND METHOD FOR REAL TIME SCHEDULING

(71) Applicant: Optibus Ltd:·, Tel Aviv (IL)

(72) Inventor: Eitan YANOVSKY, Netanya (IL)

(21) Appl. No.: 15/739,972

(22) PCT Filed: Jun. 26, 2016
(86) PCT No.: PCT/IL2016/050686

§ 371 Date: Dec. 26, 2017

(51) Int. Cl. G06Q 10/06; G06Q 50/30; G06Q 10/04; G07C 5/00

(52) U.S. Cl. CPC G06Q 10/06312; G06Q 50/30; G07C 5/004; G07C 5/008; G06Q 10/047

(57) ABSTRACT

The present invention relates to Real Time Scheduling systems. In particular, the present invention relates to real time transportation scheduling. More specifically, the present invention relates to novel improvements in transportation planning and allocation of resources on a real time basis by providing a system and method for “real time” scheduling including a client interface, a real time data processor for creating a prediction, an optimization engine electronically attached to the client interface and the real time data processor for readily producing a new schedule, and a transportation means electronically attached to the optimization engine and responsive to the new schedule.

### FIELD OF THE INVENTION

The present invention relates to Real Time Scheduling systems. In particular, the present invention relates to real time transportation scheduling. More specifically, the present invention relates to novel improvements in transportation planning and allocation of resources on a real time basis.

### BACKGROUND OF THE INVENTION

According to contemporary teachings of the art, a dispatcher, will often need to address one or more cases when the planned schedule cannot be met due to events that occur in real-time. Such events will typically include, by way of non-limiting examples only, heavy traffic causing delays, vehicular break downs and unpredicted demand.

Invariably, such events bring about an undesired result of at least one vehicle not to being able to meet with a planned schedule for that vehicle of a fleet of vehicles.

Thus, any such vehicle being late, can create bring about a further undesired outcome of delaying the next planned activity for that vehicle, line, fleet and the like.

Attempted solutions known in the art include, among others, AVL (automatic vehicle location) systems for indicating a “current location” of the vehicles.

Some attempted solutions will automatically notify that a vehicle is going to be late. Nevertheless, the systems known in the art do not offer an automatic rescheduling solution.

Moreover, a further latent deficiency of the systems known in the art is their lack of calculating planning restriction preferences and costs as an integral part of a rescheduling.

The existing scheduling systems offer offline scheduling which often take at least several hours or even days to create a new schedule and do not offer any real-time rescheduling system and especially none with an integrated with an AVL solution.

The current attempted solutions known in the art, include a dispatcher becoming aware there is a problem with a given schedule of a specific vehicle, line or fleet, and then attempts to “manually” reschedule the vehicles and drivers to address the issue. A latent deficiency of any such attempt is the limited calculative resources and limited parameters a human dispatcher can address.

It is well known he art that a dispatcher, in attempting to resolve real time scheduling dilemma, may opt to break regulations and/or offer a partial and/or inadequate solution which is far from optimal.

Even though one can find many control rooms with monitors that display the location of vehicles and in some cases display whether they are on time or going to be late to their next trip, once an indication is received that a vehicle is predicted not to perform a specific task within the time slot allocated thereto, it is up to the dispatcher to handle such an occurrence by either accepting a delay or seeking find an alternative solution utilizing the available resources of vehicles and/or drivers to replace and/or augment the delayed vehicle in completing the given task or at least one of the subsequent tasks according to the original schedule.

Often, a latent deficiency of any such system is that any solution proposed and/or implemented is based according to long running, time consuming optimizers in an offline long term process and are not suited for online solutions or providing real time basis solutions.

Any such “manual” rescheduling process is extremely challenging due to the problem size and complexity, vast number of variables and “domino effect” of any proposed solution which is far beyond the realm of the cerebral capabilities of a dispatcher.

There is a latent need to find a suitable alternative solution in a very short time frame and preferably on a substantially “real time” basis, as well as substantially contemporaneously addressing a wide range of changing and cross linked variables, different regulations, constraints and the challenge minimizing or wasting any resources.

Latent deficiencies commonly encountered by systems known in the an will often include: violations of operator rules, preferences, and regulations due to un-guarded changes; incurring delays for passengers due to the need to provide a solution in a short time period and non-optimal solution which results in inflated fleets, among others, due to large reserves being required, wasted costs and pollution due to the complexity of the problem that needs to be solved in a short time period.

### SUMMARY OF THE INVENTION

The present invention is a system and method for “real time” scheduling.

### BRIEF DESCRIPTION OF THE DRAWINGS

FIG. 1 is a block diagram view of the system and method for “real time” scheduling according to the present invention.

### DETAILED DESCRIPTION OF THE INVENTION

The system and method for “real time” scheduling according to the present invention, as described herein, readily facilitates updating/editing on a substantially “real time” basis and devoid of violations of operator rules, preferences, and regulations due to un-guarded changes; incurring delays for passengers due to the need to provide a solution in a short time period and non-optimal solution which results in inflated fleets, among others, due to large reserves being required, wasted costs and pollution due to the complexity of the problem that needs to be solved in a short time period.

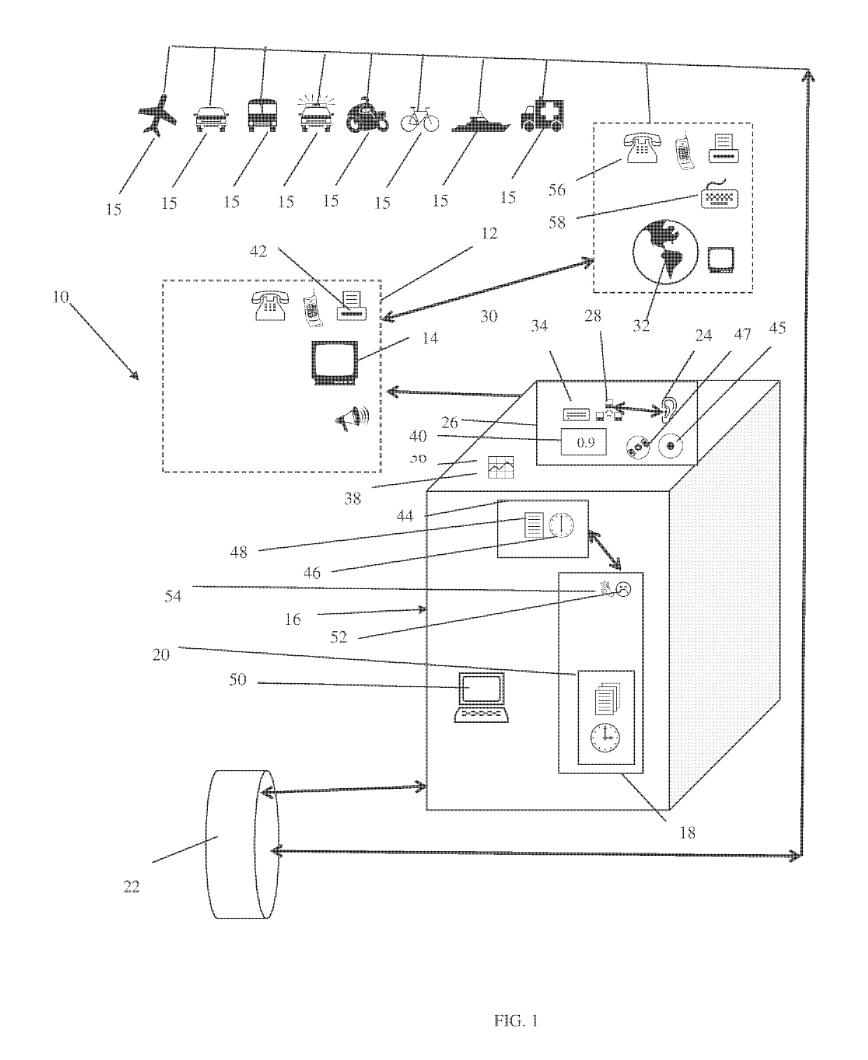

As shown in FIG. 1, a system and method for “real time” scheduling 10 according to the present invention includes a client interface 12, wherein client interface 12 is preferably displayed as a Gantt chart. Optionally, client interface 12 includes at least one map display 14 for readily displaying the location of at least one transportation means 15.

System and method for “real time” scheduling 10 preferably includes an optimization engine 16 and a data set 18, wherein data set 18 preferably includes an existing schedule 20.

Optionally, at least one map display 14 readily displaying the location of at least on sportation controller 22, wherein transportation controller 22 controls transportation means 15 either remotely or locally. By way of an unlimiting example only, transportation controller 22 may be the driver of transportation means 15.

System and method for “real time” scheduling 10 preferably also includes a real-time data listener 24 and a real-time stream processor 26.

Alternatively, client interface 12 also includes a real-time data listener 24 and a real-time stream processor 26.

Alternatively, optimization engine 16 also includes a real-time data listener 24 and a real-time stream processor 26.

Preferably, during each work session of executing existing schedule 20, a real-time feed 28 from at least one transportation means 15 is continuously fed into the real-time data listener 24 as a stream of data 30.

Stream of data 30 preferably contains a raw positioning data 32, real time feed 28, or a processed data 34 for transportation means 15.

Thus, permutations according to raw positioning data 32, real time feed 28, or a processed data 34 for transportation means 15 are readily calculated for the purpose of proactive analysis of transportation means 15 meeting schedule 20.

Real-time stream processor 26 is preferably responsive to raw positioning data 32 being received, whereupon raw positioning data 32 is passed to real-time stream processor 26 for processing and calculating the probability of transportation means 15 not meeting the time frame allocated thereto in existing schedule 20.

Preferably, Real-time stream processor 26 creates a prediction 36 based on raw positioning data 32 being received, and passed to real-time stream processor 26 on transportation means 15 meeting or not meeting the time frame allocated thereto in existing schedule 20.

Preferably, real-time stream processor 26 will accumulate and provide data on the accuracy of probability calculations compared to actual performance of transport means 15 according to existing schedule 20.

Preferably, real-time stream processor 26 includes a plurality of prediction models 45 and a history data 47 as optional parameters and/or fine tuning prediction 36.

Preferably, prediction 36 includes of an expected arrival time 38 with a confidence score 40 (probability between 0 and 1), and an expected impact 42 by knowing how many passengers are expected to he on the next trip using statistical history.

Occasioning on prediction 36 of an expected arrival time 38 not meeting existing schedule 20 from an external feed (not shown in FIG. 1) and/or the prediction 36, the expected impact 42 is calculated and the client interface 12 is notified and displays an alert with the nature and details pertaining to transportation means 15 not meeting existing schedule 20.

Optionally, real-time stream processor 26 utilizes an expected arrival time 38 from an external feed (not shown in FIG. 1) to compare to existing schedule 20, the expected impact 42 and/or prediction 36 and client interface 12 is notified and displays an alert with or without the nature and details pertaining to transportation means 15 not meeting existing schedule 20.

Optimization engine 16 is responsive to a request for a rescheduling and all the related information in a data set 18.

The information in dataset 18 mainly contains the existing schedule 20, the current location and/or raw positioning data 32 of transportation means 15 the expected arrival time 38 (both late and early), transportation controllers 22 and relevant planning constraints and preferences.

Optimization engine 16 creates at least one alternative 44 of a new schedule 46 based on existing schedule 20 which addresses delays compared to existing schedule 20.

Preferably, client interface 12 displays alternatives 44 to be selected by a dispatcher 50, controller 22 or equivalent thereof. Preferably, dispatcher 50 chooses whether to accept one or none of alternatives 44 according to the expected impact 42 and/or nature of the delay and initiates execution of new schedule 46 selected.

Optionally, controller 22 selects one or none of alternatives 44 and initiates execution of new schedule 46 selected.

Preferably, creating new schedule 46 should take a very short time, no more than a minute, in order for dispatcher 50 to have enough time to execute new schedule 46.

It is envisaged that predictions 36 should be with high probability of substantially above 50% way in advance to have time notifying all the relevant controllers 22 and transportation means 15 about their changes due to new schedule 46.

Optionally, it is envisaged that predictions 36 should be with high probability of substantially above 90% way in advance to have time notifying all the relevant controllers 22 and transportation means 15 about their changes due to new schedule 46.

For the purpose of providing an advanced and/or accurate prediction 36, real-time data processor 26 requires to process stream of data 30 including events and apply prediction models 45 to offer predictions 36 substantially on a real-time basis.

Preferably, using distributed in memory streaming processes, in memory streaming processor 26, together with a model 45 from pre-trained on history data 47, model 45 is fine-tuned and updated in a batch process from the real-time stream of data 30 using machine learning algorithms known in the art.

Preferably, Optimization engine 16 is electronically attached to or integrally formed with dataset 18, which dataset 18 preferably includes a plurality of operator planning restrictions 52, existing schedule 20 and planning preferences 54 for readily calculate a few rescheduling alternatives 44 in order for the result to be applicable.

Preferably, Optimization engine 16, creates rescheduling alternatives 44 utilizing dataset 18.

Preferably, real-time data listener 24 is an endpoint that listens to real-time feed of transportation means 15 and the raw positioning data 32 of transportation means 15 as well as processed data 34, and transfers raw positioning data 32 and/or processed data 34 to real-time stream processor 26.

Preferably, real-time stream processor 26 processes the real-time feed of stream of data 30, raw positioning data 32 and/or processed data 34.

Preferably, real-time stream processor 26 applies prediction models 45 on stream of data 30, raw positioning data 32 and/or processed data 34 combining with additional data sources such as traffic reports and the like.

Preferably, real-time stream processor 26 also keeps training and fine-tuning prediction model 45 using the accumulated data.

Occasioning on an expected impact 42 indicating a delay is predicted with high probability and of a high magnitude, preferably, client interface 12 indicates the delay and/or optimization engine 16 for a new schedule 46 and/or an alternative 44 to be calculated bearing in mind related and/or relevant expected times of arrival 38, predictions 36, models 45, history data 47, operator planning restrictions 52 and planning preferences 54.

Substantially thereafter, stream processor 26 sends the relevant dataset 18 to optimization engine 16 and substantially thereafter optimization engine 16 relays for new schedule 46 to client interface 12.

Preferably, upon client interface 12 receiving a prediction 36 of a transportation means 15 not meeting an expected time of arrival 38 according to existing schedule 20, client interface 12 displays a notice and notifies dispatcher 50 about the expected delay of transportation means 15.

Preferably, upon client interface 12 receiving a prediction 36 of a transportation means 15 not meeting an expected time of arrival 38 according to existing schedule 20, client interface 12 displays new schedule 46 and/or new expected times of arrival 48 to dispatcher 50.

Upon client interface receiving a prediction 36 of a transportation means 15 not meeting an expected time of arrival 38 according to existing schedule 20, client interface 12 displays information selected from the group consisting of: which part or existing schedule 20 is expected not to be met, raw positioning data 32 pertaining to transportation means 15 effected and other relevant transportation means 15.

Upon client interface 12 receiving a new schedule 46 and/or an alternative 44, from optimization engine 16, client interface 12 displays to dispatcher 50 at least one of the parameters selected from the group consisting of: a new schedule 46 and/or an alternative 44 thereby readily facilitating dispatcher 50 to select and/or execute a new schedule 46 and/or an alternative 44.

Preferably, occasioning on optimization engine 16 receiving a request for creating a new schedule 46, the relevant arrival predictions 36, optimization engine 16 initiates a new rescheduling process which preferably includes the following steps:
a. Parsing dataset 18 with at least one of parameters selected from group consisting of history data 47 activity for transportation means 15, planning preferences 54, planning constraints 52 and arrival predictions 36.
b. Removing from existing schedule 20 tasks of transportation means 15 effected by the delay prediction 36.
c. Starting an iterative process for rescheduling the effected tasks to other transportation means 15 and/or transportation controllers 22 (including reserve transportation means 15 and/or reserve transportation controllers 22) substantially contemporaneously with calculating and producing a cost efficient new schedule 46. Preferably, optimization engine 16 prioritizes locations that minimize disruption of tasks already in existing schedule 20, and from those to most efficient ones.
d. Occasioning on such a location not being available, optimization engine 16 will preferably calculate impact 42 of using a new transportation means 15 or replacing an existing task in existing schedule 20 effected by expected time of arrival 38 of prediction 36, and move and/or relocate the replaced task to the reschedule process as part of new schedule 46.
e. Preferably, optimization engine 16 creates a new schedule 46 and/or new expected times of arrival 48 according to preferences 54 and constraints 52.
f. Preferably, optimization engine 16 calculates new schedule 46 and/or new expected times of arrival 48 substantially contemporaneously with a plurality of prediction models 45 thereby creating a plurality of predictions 36 and/or new schedule and branching into a tree of feasible alternatives.
g. Preferably and occasioning on optimization engine 16 completing calculations of pertinent new schedules 46 and/or new expected times of arrival 48, optimization engine 16 transfers new schedules 46 and/or new expected times of arrival 48 to client interface 12 with detailed cost changes and/or impact 42 on existing schedule 20.

Preferably, real time data listener 24 is a passive component which real time data listener 24 receives raw positioning data 30.

Preferably, stream processor 26 is responsive to receiving processed data 34, and/or expected times of arrival 38 and/or predictions 36 of existing schedule 20 is expected not to be met.

Preferably, real time data listener 24 receives traffic updates from sources of traffic updates known in the art and/or external sources.

In operation, real time data listener 24 preferably transfers to stream processor 26 at least one of the parameters selected from the group consisting of: raw positioning data 30, processed data 34 with expected times of arrival 38 and predictions 36 of existing schedule 20 is expected not to be met.

By way of example only, predictions 36 of a 10 minute delay is calculated for transportation means compared to existing schedule 20. Thereafter, system and method for “real time” scheduling 10 checks whether existing schedule 20 can be optimized, the specific task can he optimized by changing route or not just the specific task being performed by the transportation means 15, thus readily addressing and substantially circumventing patterns of escalation in dataset 18.

Alternatively, system and method for “real time” scheduling 10 checks whether changing the allocation of resources and/or augmenting with assets can minimize or negate prediction 36 of expected times of arrival 38 according to existing schedule 20 not being met. Thus, preferably system and method for “real time” scheduling 10 continuously calculates, changes and adapts prediction 36 with alternating values, thereby providing a solution and/or optimizing results to reach or exceed a delay value of zero minutes or less (meaning arriving “ahead of time”).

Preferably, if a score 40 of at least 50% probability of a 5 minute delay from expected times of arrival 38 according to existing schedule 20 are reached, system and method for “real time” scheduling 10 checks whether existing schedule 20 can be optimized.

Preferably, if a score 40 of 50% probability of 5 m delay from expected times of arrival 38 according to existing schedule 20 are reached, system and method for “real time” scheduling 10 checks whether existing schedule 20 for entire day can be optimized and not just the specific task being performed by the transportation means 15, thus readily addressing and substantially circumventing patterns of escalation in dataset 18.

Preferably, if 50% probability or 5 m delay from expected times of arrival 38 according to existing schedule 20 are reached, system and method for “real time” scheduling 10 checks whether changing the allocation of resources and/or augmenting with assets can minimize or negate prediction 36 of expected times of arrival 38 according to existing schedule 20 not being met.

Preferably, calculation of new schedule 46 and/or new expected times of arrival includes number of passengers according to history data 47, thereby further fine tuning new schedule 46.

Preferably, according the embodiments and description of system and method for “real time” scheduling 10 according to the present invention, of system and method for “real time” scheduling 10 System is both reactive and proactive with regard to predictions 36 and impact 42.

Preferably, transportation means 15 includes a telemetry subsystem 56 for transferring telemetry data 58 regarding the transportation means 15 on a substantially real-time basis.

Preferably, telemetry data 58 includes at least one parameter selected from the group consisting of: a weather condition, a raw positioning data 32, a speed, a tire pressure, an oil pressure, a G force in 3 axis, a tire rate of deterioration, an acceleration rate, an oil temperature, a water temperature, an engine temperature, a wheel speed, a suspension displacement, controller 22 information, a two way telemetry transmission for remote updates, calibration and adjustments of a component of transportation means 15, expected tire change required, expected refueling required and an expected servicing required.

By way of example only, prediction 36 can produce a new planning restriction 54 due to a scheduled and/or required maintenance, pit stop, refuel, and tire change and the like.

The term “transportation means ” as used herein, shall include but will not be limited to: a means of conveyance or travel from one place to another including a vehicle or system of vehicles, such as a bus, a train, a ship, a boat, a taxi, a car, an automobile, a two and three wheeled vehicle, a sea vessel, an aircraft or an airborne carrier and the like for private and public conveyance of passengers or goods especially as a commercial enterprise, a means of transportation, a controller of a means of transportation, a bank energy resource for a means of transportation, a loading station for loading a means of transport, an off-loading station for off-loading a means of transport and the like.

It will be appreciated that the above descriptions are intended to only serve as examples, and that many other embodiments are possible within the spirit and scope of the present invention.

What is claimed is:

1. A system and method for “real time” scheduling comprising:
(a) a client interface;
(b) a real time data processor for creating a prediction
(c) an optimization engine electronically attached to said client interface and said real time data processor for readily producing a new schedule; and
(d) a transportation means electronically attached to said optimization engine and responsive to said new schedule.

2. The system and method for “real time” scheduling of claim 1, further comprising a dataset including at least one parameter selected from the group consisting of: a plurality of tasks, a history data, a prediction model, a planning constraint and a planning preference.

3. The system and method for “real time” scheduling of claim 2, wherein said client interface further comprising a controller.

4. The system and method for “real time” scheduling of claim 3, wherein real time data processor is responsive to a set of telemetry data, wherein telemetry data includes at least one parameter selected from the group consisting of: a weather condition, a raw positioning data, a speed, a tire pressure, an oil pressure, a G force in 3 axis, a tire rate of deterioration, an acceleration rate, an oil temperature, a water temperature, an engine temperature, a wheel speed, a suspension displacement, a controller information, a two way telemetry transmission for remote updates, calibration and adjustments of a component of transportation means, expected tire change required, expected refueling required and an expected servicing required.

5. A system and method for “real time” scheduling comprising:
(a) a client interface including a controller;
(b) a real time data processor for creating a prediction
(c) an optimization engine electronically attached to said client interface and said real time data processor for readily producing a new schedule;
(d) a transportation means electronically attached to said optimization engine and responsive to said new schedule; and
(e) a dataset including at least one parameter selected from the group consisting of: a plurality of tasks, a history data, a prediction model, a planning constraint and a planning preference.

6. The system and method for “real time” scheduling of claim 5, wherein said real time data processor is responsive to a set of telemetry data, and wherein said telemetry data includes at least one parameter selected from the group consisting of: a weather condition, a raw positioning data, a speed, a tire pressure, an oil pressure, a G force in 3 axis, a tire rate of deterioration, an acceleration rate, an oil temperature, a water temperature, an engine temperature, a wheel speed, a suspension displacement, a controller information, a two way telemetry transmission for remote updates, calibration and adjustments of a component of transportation means, expected tire change required, expected refueling required and an expected servicing required.

7. The system and method for “real time” scheduling of claim 5, wherein said client interface includes at least one map display for readily displaying the location of said transportation means.

8. The system and method for “real time” scheduling of claim 5, wherein said dataset includes at least one existing schedule.

9. The system and method for “real time” scheduling of claim 7, wherein said at least one map display readily displays the location of at least one transportation controller.

10. The system and method for “real time” scheduling of claim 9, wherein said transportation controller controls said transportation means remotely or locally.

11. The system and method for “real time” is the driver of said transportation means.

12. The system and method for “real time” scheduling of claim 5, further comprising a real-time data listener and a real-time stream processor.

13. The system and method for “real time” scheduling of claim 12, wherein executing said existing schedule, during each work session, a real-time feed from at least one said transportation means is continuously fed into said real-time data listener as a stream of data.

14. The system and method for “real time” scheduling of claim 13, wherein said stream of data preferably includes a raw positioning data, a real time feed, or a processed data for said transportation means.

15. The system and method for “real time” scheduling of claim 14; wherein said real-time stream processor is preferably responsive to said raw positioning data being received, whereupon said raw positioning data is passed to said real-time stream processor for processing and calculating the probability of said transportation means not meeting the time frame allocated thereto in said existing schedule.

16. The system and method for “real time” scheduling of claim 15, wherein said real-time stream processor creates a prediction based on said raw positioning data being received, and passed to said real-time stream processor on said transportation means meeting or not meeting the time frame allocated thereto in said existing schedule.

17. The system and method for “real time” scheduling of claim 15, wherein said optimization engine is electronically attached to or integrally formed with said dataset, and which dataset preferably includes a plurality of operator planning restrictions, said existing schedule and a plurality of planning preferences for readily calculating at least one rescheduling alternative.

18. The system and method for “real time” scheduling of claim 15, wherein said real-time data listener is an endpoint that listens to said real-time feed of said transportation means and said raw positioning data of said transportation means as well as said processed data, and transfers said raw positioning data and/or said processed data to said real-time stream processor.

19. The system and method for “real time” scheduling of claim 15, wherein said real-time stream processor applies at least one prediction model on said stream of data, said raw positioning data and/or said processed data and wherein said real-time stream processor keeps training and fine-tuning said at least one prediction model using the accumulated data.

20. The system and method for “real time” scheduling of claim 15, wherein if a score of at least 50% probability of a 5 minute delay from an expected times of arrival according to said existing schedule are reached, said system and method for “real time” scheduling performs at least one of the tasks selected from the group consisting of: checking whether said existing schedule can be optimized, checking whether said existing schedule for an entire day can be optimized for readily addressing and substantially circumventing patterns of escalation in said dataset, checking whether a change in an allocation of resources and/or an augmentation with at least one asset can minimize said prediction of said expected times of arrival according to said existing schedule not being met.
